(19) United States
(12) Patent Application Publication
(10) Pub. No.: US 2018/0260014 A1
(43) Pub. Date: Sep. 13, 2018

(54) SYSTEMS AND METHODS FOR CONTROLLING MEMORY ARRAY POWER CONSUMPTION

(71) Applicant: NXP USA, Inc., AUSTIN, TX (US)

(72) Inventors: Patrice M. PARRIS, PHOENIX, AZ (US); Weize CHEN, Phoenix, AZ (US); Md M. HOQUE, GILBERT, AZ (US); Frank Kelsey BAKER, JR., Austin, TX (US); Victor WANG, Austin, TX (US); Joachim Josef Maria KRUECKEN, Muenchen (DE)

(21) Appl. No.: 15/452,166

(22) Filed: Mar. 7, 2017

(51) Int. Cl. G06F 1/32; G06F 9/48

(52) U.S. Cl. CPC G06F 1/3275; G06F 9/4881; G06F 1/3287

(57) ABSTRACT

A memory system has a memory array divided into a plurality of sub-arrays in which each sub-array has a mutually exclusive power domain, task scheduler circuitry coupled to the memory array, and sub-array power control circuitry coupled to the task scheduler circuitry. A method includes selecting, by the task scheduler circuitry, a task for execution, providing a control signal to the sub-array power control circuitry indicative of a set of sub-arrays to power based on the selected task, and setting a power state of each sub-array, by the sub-array control circuitry, in response to the control signal.

### BACKGROUND

### Field

This disclosure relates generally to semiconductor memory devices, and more specifically, to controlling power consumption in memory devices.

### Related Art

As microprocessors and microcontrollers expand their application spaces, the size of associated executable code and data has also grown. Larger code and data sizes force larger memory array sizes. The increased bitcount causes power consumption of these arrays to also increase. In addition, these more powerful microcontrollers and microprocessors are fabricated in more advanced complementary metal oxide semiconductor (CMOS) technology nodes with ever-decreasing size. With smaller geometry, there is a corresponding increase in static power consumption. This rise in power consumption is an issue, particularly for embedded microcontrollers and microcontrollers which are intended for Internet of Things (IoT) applications where portable devices typically run off of limited battery power.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 illustrates a block diagram of an embodiment of a semiconductor processing system with memory array in accordance with the present invention.

FIG. 2 illustrates a block diagram of another embodiment of a semiconductor processing system with memory array in accordance with the present invention.

FIG. 3 illustrates a block diagram of yet another embodiment of a semiconductor processing system with memory array in accordance with the present invention.

FIG. 4 illustrates a diagram of an embodiment of a scheduling control block that may be used with the semiconductor processing system in FIGS. 1, 2 and 3.

FIG. 5 illustrates a flow diagram of an embodiment of a method for selectively biasing sub-arrays of memory in a memory array that can be used with the processing systems of FIGS. 1-3.

### DETAILED DESCRIPTION

Embodiments of devices and methods disclosed herein include a power-gated, sectored array architecture with combined software and hardware components to eliminate or minimize any performance penalty. A memory array is split into sub-arrays, each of which can be biased with power for Standby, Read, Program and Erase operations independently of the other sectors. In some instances, some operations, like ERASE, may still be carried out with different granularity, e.g. multiple sectors simultaneously, than the remaining operations. Logic circuitry and switches associated with the array control which sub-arrays are biased at any time. An optional optimizing compiler or post-compilation optimizer can be used to create data allowing the system to select which sectors of the memory array are biased based on the probability of being used for a particular task or section of code.

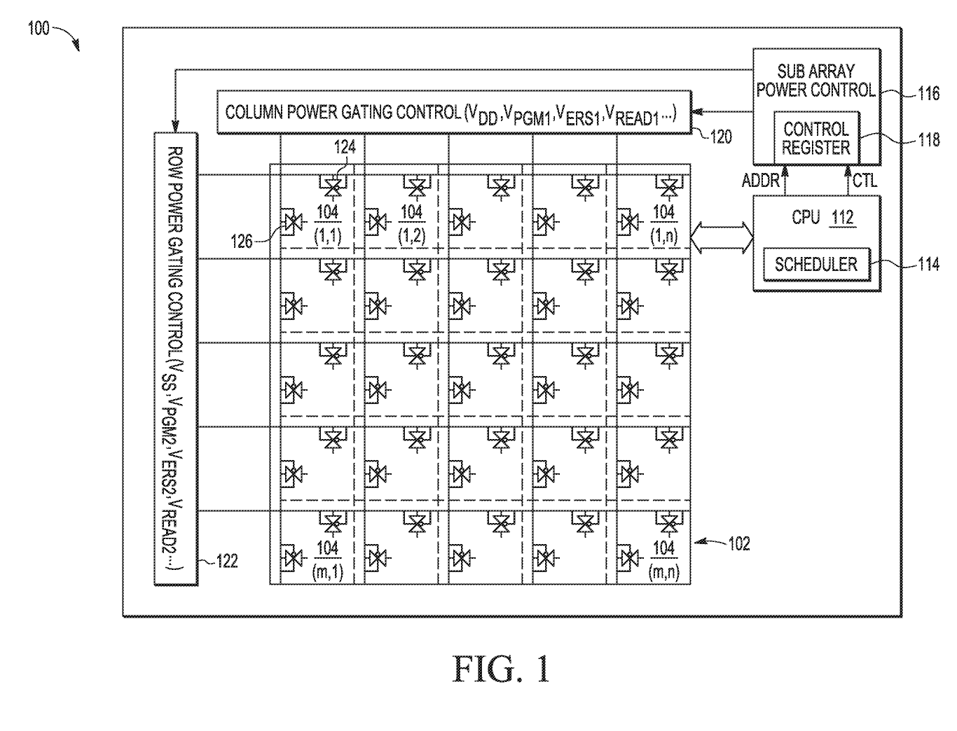

FIG. 1 illustrates a block diagram of an embodiment of semiconductor processing system 100 with memory array 102 in accordance with the present invention. Memory array 102 includes m rows and n columns of groups of memory cells in memory sub-arrays 104. Memory array 102 is coupled to communicate with central processing unit (CPU) 112 that includes scheduler circuitry 114. Scheduler circuitry can alternatively be placed outside CPU 112. CPU 112 is also coupled to communicate address and control information with sub-array power control circuitry 116. Control register 118 is included in sub-array power control circuitry 116 to store data indicating which sub-arrays 104 are to be biased with power and which sub-arrays 104 can be placed or are to remain in a low or reduced power mode to conserve power. Sub-array power control circuitry 116 is coupled to communicate with column power gating control circuitry 120 and to row power gating control circuitry 122 to indicate which sub-arrays 104 are to be biased with power based on the address(es) provided by scheduler circuitry 114 to sub-array power control circuitry 116. Memory array 102 can be used to store program code instructions, data, or both, and can be implemented using volatile memory such as various types of random access memory (RAM), or non-volatile memory such as flash or magnetoresistive memory. The address to each location in memory can be mapped from a logical address used by CPU 112 to a physical address in memory array 102.

Each memory sub-array 104 includes row switch 124 and column switch 126 that is coupled to respective row power gating control circuitry 122 and column power gating control circuitry 120. When a particular sub-array 104 is to be biased with power, selected column switch(es) 126 will be placed in conductive mode to allow voltages from power domains such as supply voltage VDD, program voltage VPGM, erase voltage VERASE, read voltage VREAD to be applied to selected columns of array 102. Selected row switch(es) 124 will be placed in conductive mode to allow voltages such as supply voltage VSS, program voltage VPGM, erase voltage VERS, and read voltage VREAD to be applied to selected rows of array 102. A particular sub-array 104 will be fully powered when both the respective appropriate row switches 124 and appropriate column switches 126 are in conductive mode. Otherwise, a sub-array 104 without both row switch 124 and column switch 126 in conductive mode will be in a power-down mode. Note that switches 124 and 126 can be implemented as either one switch per line, or one or more switches that control connection of the signal lines to a particular sub-array 104.

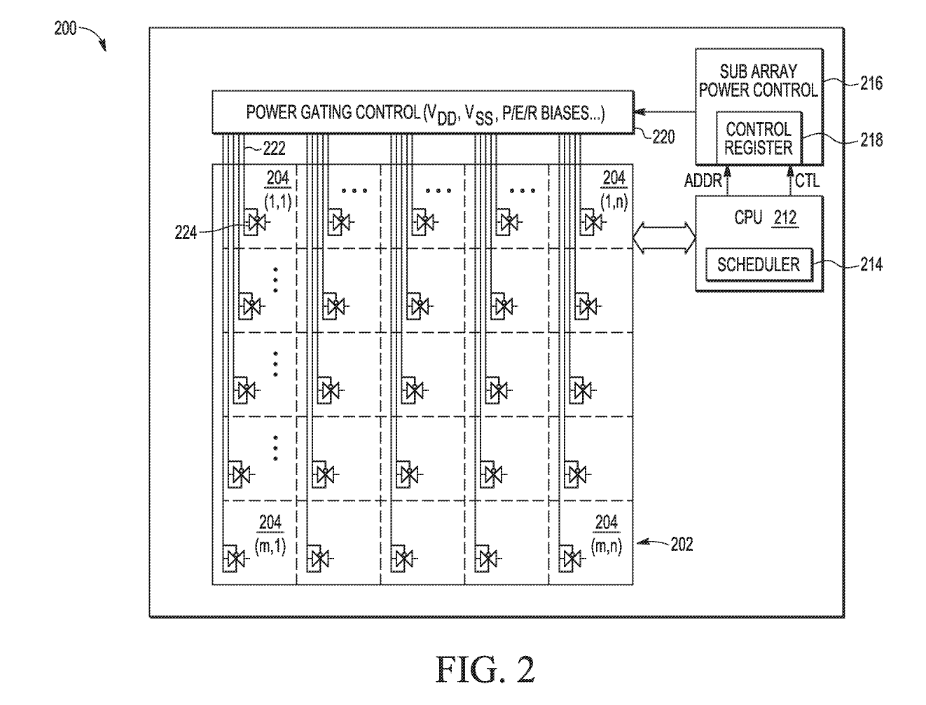

FIG. 2 illustrates a block diagram of another embodiment of a semiconductor processing system 200 with memory array 202 in accordance with the present invention. Memory array 202 includes m rows and n columns of groups of memory cells in memory sub-arrays 204. Memory array 202 is coupled to communicate with central processing unit (CPU) 212 that includes scheduler circuitry 214. CPU 212 is also coupled to communicate address and control information to sub-array power control circuitry 216. Control register 218 is included in sub-array power control circuitry 216 to store data indicating which sub-arrays 204 are to be biased with power and which sub-arrays 204 can be placed or are to remain in a low or reduced power mode to conserve power. Sub-array power control circuitry 216 is coupled to communicate with column power gating control circuitry 220 to indicate which sub-arrays 204 are to be biased with power based on the address(es) provided by scheduler circuitry 214 to sub-array power control circuitry 216. Memory array 202 can be used to store program code instructions, data, or both. The address to each location in memory array 202 can be mapped from a logical address used by CPU 212 to a physical address in memory array 202.

Each memory sub-array 204 includes a column switch 224 coupled to column power gating control circuitry 220 by a respective conductive line 222. Thus, power can be provided to each sub-array 204 independently of the other sub-arrays 204. When a particular sub-array 204 is to be biased with power, selected column switch(es) 224 will be placed in conductive mode to allow voltages from power domains such as supply voltages VDD and VSS, and program, erase, and read voltage biases to be applied to selected columns of memory array 202. A particular sub-array 204 will be fully powered when the appropriate column switches 224 are in conductive mode. Otherwise, a sub-array 204 with column switch 224 in non-conductive mode will be in a power-down mode. Note that switches 224 can be implemented as either one switch per line, or one or more switches that control connection of the signal lines to a particular sub-array 204.

Note that instead of column power gating control circuitry 220 and conductive lines 222 and switch 224 for each column, each row in array 202 can be connected to conductive lines across each row and to row power gating control circuitry (not shown).

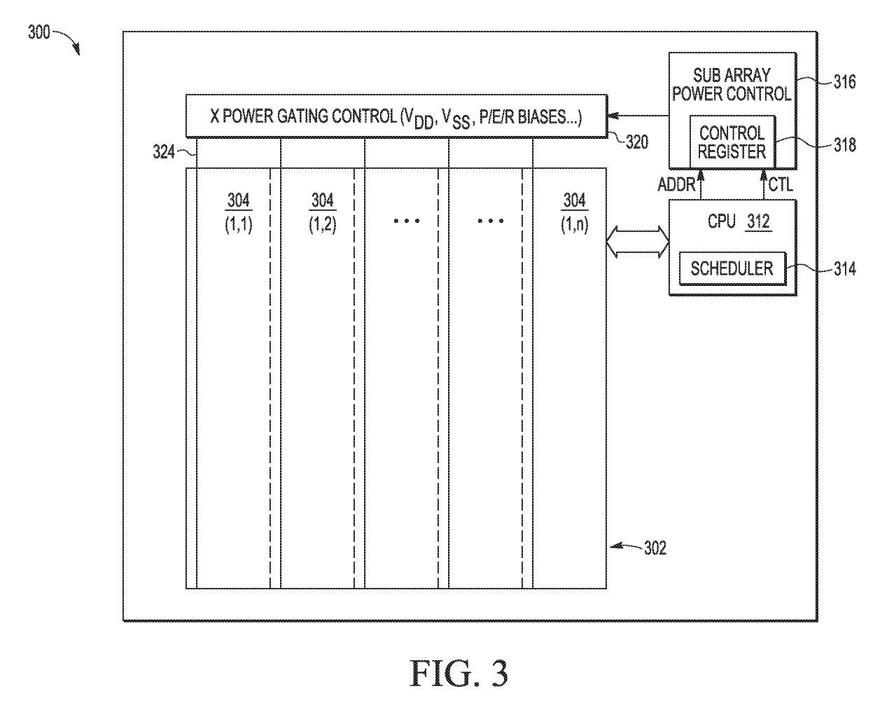

FIG. 3 illustrates a block diagram of yet another embodiment of a semiconductor processing system 300 with memory array 302 in accordance with the present invention. Memory array 302 includes one row with n columns of memory sub-arrays 304. Memory array 302 is coupled to communicate with central processing unit (CPU) 312 that includes scheduler circuitry 314. CPU 312 is also coupled to communicate address and control information with sub-array power control circuitry 316. Control register 318 is included in sub-array power control circuitry 316 to store data indicating which sub-arrays 304 are to be biased with power and which sub-arrays 304 can be placed or are to remain in a low or reduced power mode to conserve power. Sub-array power control circuitry 316 is coupled to communicate with column power gating control circuitry 320 to indicate which sub-arrays 304 are to be biased with power based on the address(es) provided by scheduler 314 to sub-array power control circuitry 316. Memory array 302 can be used to store program code instructions, data, or both. The address to each location in memory array 302 can be mapped from a logical address used by CPU 312 to a physical address in memory array 302.

Each memory sub-array 304 is coupled to column power gating control circuitry 320 by respective conductive lines 324. Thus, power can be provided to each sub-array 304 independently of the other sub-arrays 304. When a particular sub-array 304 is to be biased with power, voltages from power domains such as supply voltages VDD and VSS, and program, erase, and read voltage can be applied to selected memory sub-array(s) 304 as needed. A particular sub-array 304 will be fully powered when the voltages and biases are provided on respective conductive line 324. Otherwise, a sub-array 304 without power will be in a power-down mode. Note that instead of column power gating control circuitry 320 and conductive lines 324 for each column, each row in array 302 can be connected to conductive lines across each row and to row power gating control circuitry (not shown).

Referring to FIGS. 1-4, FIG. 4 illustrates a diagram of an embodiment of a scheduling control block 400 that may be used with semiconductor processing systems 100, 200 and 300 in respective FIGS. 1, 2 and 3. Scheduling control block 400 can be stored in a buffer in scheduler circuitry 114, 214, 314 or other suitable location in processing systems 100, 200, 300. The data in scheduling control block 400 is used to determine which sub-arrays 104, 204, 304 to bias with power when a particular task is executing. Sub-arrays 104, 204, 304 not being used or with a low-enough probability of imminent use can be powered down.

Scheduling control block 400 is generated by analyzing each task or set of software instructions or code to be executed or being executed on CPU 112, 212, 312 to determine sub-arrays 104, 204, 304 of memory arrays 102, 202, 302 used by each task or with a high-enough probability of being next accessed after the current sub-array(s) 104, 204, 304 in use. In the example of scheduling control block 400 shown, scheduling control block 400 shows task 1 in processing system 100 using sub-arrays 104(1,1) and 104(1,2). Task 2 in processing system 100 uses sub-array 104(3,3). Task 3 in processing system 100 uses sub-arrays 104(4,2), 104(4,3), 104(5,3) and 104(6,2). Additional (or fewer) tasks can be included in scheduling control block 400, as required. Each task can have both ‘sub-arrays 104, 204, 304 in use now’ and ‘sub-arrays 104, 204, 304 with a high-enough probability of being used next’ values. The high-enough probability value enables a trade-off of performance versus power consumption. The higher the probability cut-off the lower the power consumption (fewer sub-arrays 104, 204, 304 powered) but the higher the chance that the system will next need access to an unpowered sub-array 104, 204, 304, have to wait for the sub-array 104, 204, 304 to be powered up and suffer a resulting performance degradation. A system designer can decide whether the cut-off is fixed at compile time, varies dynamically based on available battery power, or varies dynamically based on some function of other inputs, like user preference or application space. Dynamic operation requires a more complex control block 400 where the possible ‘next’ sectors can be grouped by probability of imminent execution.

Referring to FIGS. 1-5, FIG. 5 illustrates a flow diagram of an embodiment of a method 500 for selectively biasing sub-arrays of memory in a memory array that can be used with the processing systems of FIGS. 1-3. Process 502 includes analyzing the code, data, or both, depending on the planned contents of arrays 102, 202, 302, to correlate sub-arrays with tasks. The analysis of sub-array(s) 104, 204, 304 used by a particular task can be performed when code for the task is compiled, and/or before, during or after a task is executed. If the analysis is performed after the code is executed, the analysis can be stored for use the next time the task is executed.

As an example of a way to determine which sub-arrays 104, 204, 304 are to be biased is to not bias other sub-arrays 104, 204, 304 until the next instruction to be executed by a task is outside of the current sub-array 104, 204, 304. Once this happens, the new sub-array is biased while biases are removed from the previously-biased sub-array. Even though the power gating circuitry 120, 122, 220, 320 consumes some power, the static power consumed by array 102, 202, 302 with N sub-arrays is reduced by a factor of N.

In another method for determining which sub-arrays 104, 204, 304 to bias, the sub-array(s) 104, 204, 304 physically closest to the sub-array 104, 204, 304 currently being used are biased. Assume a total of M sub-arrays 104, 204, 304 are biased. Even with the additional power consumption by power gating circuitry 120, 122, 220, 320, static power consumption for an array 102, 202, 302 with N sub-arrays is proportional to a factor of M/N instead of N. Biasing more sub-arrays increases the probability that, when execution jumps out of the current sub-array, the next instruction will be in an already-biased sub-array and decreases the performance impact of not biasing the entire array 102, 202, 302. The optimum value of M for a given N will be application-dependent.

In yet another method for determining which sub-arrays 104, 204, 304 to bias, the sub-array 104, 204, 304 containing the addresses next in sequence after those of the currently executing sub-array 104, 204, 304 is biased. Optionally one or more sub-arrays 104, 204, 304 with addresses after the next sub-array 104, 204, 304 to a selected depth, D, can also be biased. For the additional power consumption, static power consumption for an array with N sub-arrays 104, 204, 304 is reduced by a factor of (D+1)/N.

In a further method for determining which sub-arrays 104, 204, 304 to bias, either during or after compilation, the compiled code for a task can be optimized to remove unused and unreachable code. During this process and, if necessary, in additional optimizing passes, the optimizer constructs, for each sub-array 104, 204, 304, a list of the sub-arrays 104, 204, 304 containing addresses to which code in the sub-array being analyzed can jump, whether through interrupts, subroutine calls or other means. Optionally, the optimizer can create a jump tree of sub-arrays 104, 204, 304 by further tracing subsequent jumps. The optimum depth of this tree depends, in part, on the target reduction in power consumption, the input high-level program, language and compiler. If the optimizer is allowed to proceed past the first jump, the maximum number of sub-arrays 104, 204, 304 on any branch of the tree can be set to limit the number of sub-arrays 104, 204, 304 that can potentially be biased.

When the executable task is loaded, the linked tree can be passed to sub-array power control circuitry 116, 216, 316 along with either the address or sub-array 104, 204, 304 of the first instruction to be executed. Throughout execution, sub-array power control circuitry 116, 216, 316 can have the relevant address or sub-array information updated either on every clock cycle or whenever execution leaves the current sub-array 104, 204, 304. Sub-array power control circuitry 116, 216, 316 uses the presented address/sub-array information, the stored jump tree and, optionally, a local maximum number of sub-arrays 104, 204, 304 that can be biased to compute which sub-arrays 104, 204, 304 to bias at any time during operation.

In still a further method for determining which sub-arrays 104, 204, 304 to bias, as the high-level code is written, the programmer supplies a type and acceptable range for each input variable and parameter. Either during compilation or in a post-compilation operation, the compiled code is optimized to remove unused and unreachable code. The optimizer can be provided with data on the target memory array architecture. During the optimization process the optimizer runs a stochastic simulation, such as a Monte Carlo simulation, repeatedly running the code with randomly selected values of the variables and parameters to compile, for each sub-array 104, 204, 304, the probability of a jump to all other sub-arrays 104, 204, 304. Optionally, the optimizer can create additional statistics, such as the average number of cycles spent in the executing sub-array 104, 204, 304 before execution jumps to either any other sub-array 104, 204, 304 or each of the other sub-arrays 104, 204, 304 or a probability tree for further subsequent jumps. The optimum depth of this tree depends, in part, on the target reduction in power consumption, the input high-level program, language and compiler. If the optimizer is allowed proceed past the first jump, the maximum number of subsequent jumps on any branch of the tree can be set to limit how many sub-arrays can potentially be biased. Once the probability tree has been constructed, the optimizer stores it in the executable with the assembly code.

When the executable is loaded, the probabilities can be passed to sub-array power control circuitry 116, 216, 316 along with either the address or sub-array 104, 204, 304 of the first instruction to be executed. Throughout execution, sub-array power control circuitry 116, 216, 316 can have the relevant address or sub-array information updated either on every clock cycle or whenever execution leaves the current sub-array 104, 204, 304. Sub-array power control circuitry 116, 216, 316 uses the presented address/sub-array information, the stored probabilities, a probability threshold for biasing and, optionally, a local maximum number of sub-arrays 104, 204, 304 that can be biased to compute which sub-arrays 104, 204, 304 to bias at any time during operation.

Referring again to FIG. 5, process 504 can include programming scheduling control block 400 with sub-arrays correlated to each task. For example, the data resulting from the analysis in process 502 can be stored in scheduling control block 400 in process 504. In addition, scheduling control block 400 can be updated dynamically when sub-arrays 104, 204, 304 used by a task do not match the data in scheduling control block 400 after one or more executions of the corresponding task. Data in scheduling control block 400 can remain indefinitely or be removed or replaced if a task is no longer running.

During operation of processing system 100, 200, 300, process 506 includes selecting a next task for execution by scheduler 114, 214, 314. A task may be selected based on priority, availability of resources, occurrence of a specified event, a specified time, and/or other chosen criteria such as user input or other external stimulus.

In process 508, scheduler 114, 214, 314 determines sub-arrays to receive power based on the task to be executed and sub-arrays 104, 204, 304 of memory array 102, 202, 302 to be used by the task. The memory usage can be based on the address(es) provided to CPU 114, 214, 314, and/or information resulting from analysis of a task during compilation and optimization in process 502. Once the sub-array(s) 104, 204, 304 to be used for a task are determined, control signals can be sent from scheduler 114, 214, 314 to sub-array power control circuitry 116, 216, 316. The control signals may be stored in control register 118, 218, 318.

In process 510, sub-array power control circuitry 116, 216, 316 sets the power state of each sub-array 104, 204, 304 by sending signals to power gating control circuitry 120, 122, 220, 320 that control which voltages are applied to which sub-array 104, 204, 304. In some implementations, signals are sent to operate row switches 124 and column switches 126, 224 to control which sub-arrays 104, 204, 304 receive power and which remain in a power-down or reduced power state. In other embodiments, such as shown in FIG. 3, sub-arrays 104, 204, 304 connected to selected rows or columns receive power, while rows and columns that are not selected remain in power-down or reduced power states. Process 510 transitions back to process 506 until operation of CPU 112, 212, 312 or scheduler 114, 214, 314 is halted.

By now it should be appreciated that in selected embodiments there has been provided, in a memory system (100, 200, 300) having a memory array (102, 202, 302) divided into a plurality of sub-arrays (104, 204, 304) in which each sub-array has a mutually exclusive power domain, task scheduler circuitry (114, 214, 314) coupled to the memory array, and sub-array power control circuitry (116, 216, 316) coupled to the task scheduler circuitry, a method can comprise selecting, by the task scheduler circuitry, a task for execution (506); providing a control signal to the sub-array power control circuitry indicative of a set of sub-arrays to power based on the selected task (508); and setting a power state of each sub-array, by the sub-array control circuitry, in response to the control signal (510).

In another aspect, the power state of each sub-array of the set of sub-arrays can be powered up.

In another aspect, the power state of each sub-array not in the set of sub-arrays can be reduced power.

In another aspect, the power state of each sub-array not in the set of sub-arrays can be powered down.

In another aspect, each sub-array can include power gating circuitry (120, 122 and switches, etc.) such that the sub-array control circuitry controls the power gating circuitry of each sub-array to set the power state.

In another aspect, the memory can be a non-volatile memory.

In another aspect, the memory can be a random access memory (RAM).

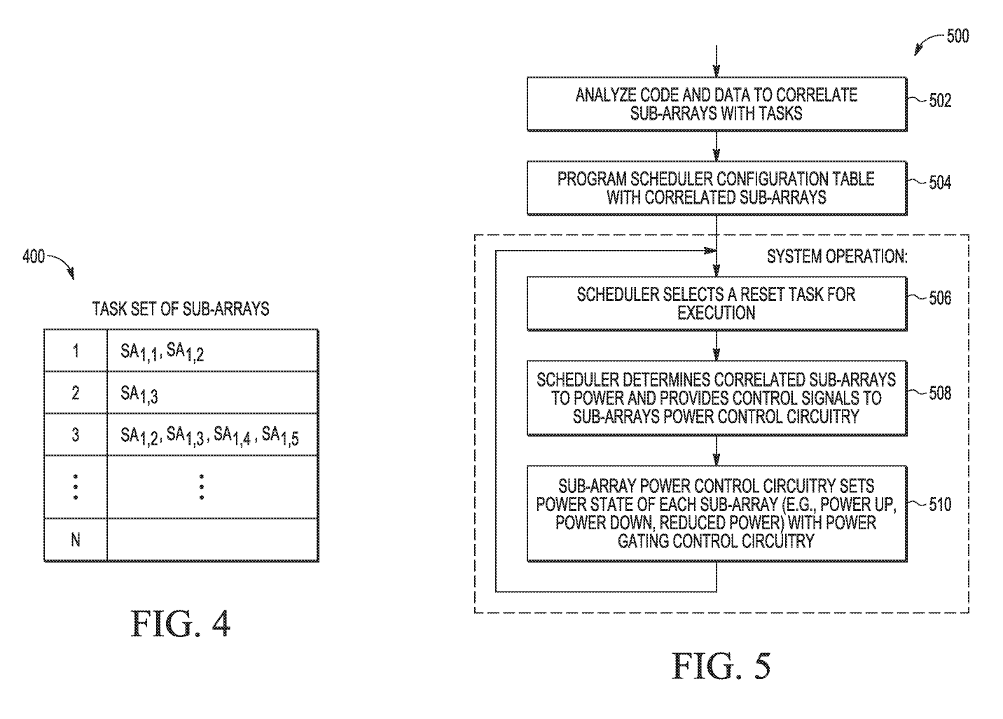

In another aspect, the task scheduler circuitry can include stored configuration information (FIG. 4) which indicates a corresponding set of sub-arrays used by each task of a plurality of tasks. The control signal can be provided by the task scheduler circuitry based on the selected task and the configuration information.

In another aspect, the method can further comprise analyzing information to be stored in the memory array (502); in response to analyzing the information to be stored in the memory array, determining the corresponding set of sub-arrays used by each task (502); and programming the configuration information into the task scheduler circuitry (504).

In another aspect, analyzing the information comprises analyzing executable instructions to be stored in the memory array.

In other selected embodiments, in a memory system having a memory array divided into a plurality of sub-arrays in which each sub-array has a mutually exclusive power domain, sub-array power control circuitry coupled to memory array, and a central processing unit (CPU) coupled to the memory array, a method can comprise determining, by the sub-array power control circuitry, a subset of the sub-arrays to power up based on a physical location in the memory array of information to be accessed by the CPU; powering up each sub-array of the subset of sub-arrays and reducing power to each sub-array not in the subset of sub-arrays, wherein the subset of sub-arrays includes the information; and after the powering up each sub-array of the subset of sub-arrays, accessing the information.

In another aspect, the information to be accessed by the CPU includes code to be executed by the CPU.

In another aspect, the method can further comprise receiving a next instruction to be executed by the CPU. The determining the subset of sub-arrays to power up can be based on an address of the next instruction. The subset of the sub-arrays can include a sub-array containing the address of the next instruction.

In another aspect, the subset of the sub-arrays can further include a sub-array physically closest to the sub-array containing the address of the next instruction.

In another aspect, the method can further comprise storing a depth value, D, wherein D (118, 218, 318) is an integer greater than zero, and wherein the subset of the sub-arrays includes D sub-arrays which contain addresses in sequence after the address of the next instruction.

In another aspect, reducing power to each sub-array not in the subset of sub-arrays includes removing power from each sub-array not in the subset of sub-arrays.

In other selected embodiments, a memory system (100, 200, 300) can comprise a memory array divided into a plurality of sub-arrays in which each sub-array has a mutually exclusive power domain; task scheduler circuitry coupled to the memory array and configured to select a task for execution; and sub-array power control circuitry coupled to the task scheduler circuitry. The task scheduler circuitry can be configured to provide a control signal to the sub-array power control circuitry indicative of a set of sub-arrays to power based on the selected task, and the sub-array power control circuitry can be configured to set a power state of each sub-array in response to the control signal.

In another aspect, each sub-array can comprise power gating circuitry. The sub-array power control circuitry can be configured to control the power gating circuitry of each sub-array to set the power state.

In another aspect, the task scheduler circuitry can comprise storage circuitry configured to store configuration information which indicates a corresponding set of sub-arrays used by each task of a plurality of tasks.

In another aspect, the task scheduler circuitry can be configured to provide the control signal based on the selected task and the configuration information.

Because the apparatus implementing the present disclosure is, for the most part, composed of electronic components and circuits known to those skilled in the art, circuit details will not be explained in any greater extent than that considered necessary as illustrated above, for the understanding and appreciation of the underlying concepts of the present disclosure and in order not to obfuscate or distract from the teachings of the present disclosure.

Some of the above embodiments, as applicable, may be implemented using a variety of different information processing systems. For example, although FIGS. 1-3 and the discussion thereof describe exemplary information processing architectures, the exemplary architectures are presented merely to provide a useful reference in discussing various aspects of the disclosure. Systems and methods disclosed herein can also apply to three-dimensional physical and N-dimensional logical arrays with additional switches. A three-dimensional array, for example, would require the addition of column power gating and column switches. Of course, the description of the architecture has been simplified for purposes of discussion, and it is just one of many different types of appropriate architectures that may be used in accordance with the disclosure. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

System 100, 200, 300 can include additional components for operating memory array 102, 202, 302 that are not shown to simplify FIGS. 1, 2 and 3. For example, system 100, 200, 300 can include row decode circuitry and column decode circuitry to map logical addresses used in CPU 112, 212, 312 to physical addresses is memory array 102, 202, 302, sense amplifiers, voltage generators, charge pumps, and other suitable components. In selected embodiments, system 100, 200, 300 is a computer system such as a personal computer system that includes one or more CPUs 112, 212, 312 or processing cores. One CPU may act as a master with other processing cores operating under the direction of the master CPU. Another alternative is to have all the cores communicate with a master scheduler 114, 214, 314, which then controls the biasing of sub-arrays 104, 204, 304. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless and Internet-of-things devices.

Also for example, in one embodiment, the illustrated elements of system 100, 200, 300 are circuitry located on a single integrated circuit or within a same device. Alternatively, system 100, 200, 300 may include any number of separate integrated circuits or separate devices interconnected with each other. For example, memory array 102, 202, 302 may be located on a same integrated circuit CPU 112, 212, 312 or on a separate integrated circuit or located within another peripheral or slave discretely separate from other elements of system 100, 200, 300. Peripheral(s) and I/O circuitry may also be located on separate integrated circuits or devices. Also for example, system 100, 200, 300 or portions thereof may be soft or code representations of physical circuitry or of logical representations convertible into physical circuitry. As such, system 100, 200, 300 may be embodied in a hardware description language of any appropriate type.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. In a memory system having a memory array divided into a plurality of sub-arrays in which each sub-array has a mutually exclusive power domain, task scheduler circuitry coupled to the memory array, and sub-array power control circuitry coupled to the task scheduler circuitry, a method comprising:
selecting, by the task scheduler circuitry, a task for execution;
providing a control signal to the sub-array power control circuitry indicative of a set of sub-arrays to power based on the selected task; and
setting a power state of each sub-array, by the sub-array control circuitry, in response to the control signal.

2. The method of claim 1, wherein the power state of each sub-array of the set of sub-arrays is powered up.

3. The method of claim 2, wherein the power state of each sub-array not in the set of sub-arrays is reduced power.

4. The method of claim 2, wherein the power state of each sub-array not in the set of sub-arrays is powered down.

5. The method of claim 1, wherein each sub-array includes power gating circuitry such that the sub-array control circuitry controls the power gating circuitry of each sub-array to set the power state.

6. The method of claim 1, wherein the memory is a non-volatile memory.

7. The method of claim 1, wherein the memory is a random access memory (RAM).

8. The method of claim 1, wherein the task scheduler circuitry includes stored configuration information which indicates a corresponding set of sub-arrays used by each task of a plurality of tasks, and wherein the control signal is provided by the task scheduler circuitry based on the selected task and the configuration information.

9. The method of claim 8, further comprising:
analyzing information to be stored in the memory array;
in response to analyzing the information to be stored in the memory array, determining the corresponding set of sub-arrays used by each task; and
programming the configuration information into the task scheduler circuitry.

10. The method of claim 9, wherein analyzing the information comprises analyzing executable instructions to be stored in the memory array.

11. In a memory system having a memory array divided into a plurality of sub-arrays in which each sub-array has a mutually exclusive power domain, sub-array power control circuitry coupled to memory array, and a central processing unit (CPU) coupled to the memory array, a method comprising:
determining, by the sub-array power control circuitry, a subset of the sub-arrays to power up based on a physical location in the memory array of information to be accessed by the CPU;
powering up each sub-array of the subset of sub-arrays and reducing power to each sub-array not in the subset of sub-arrays, wherein the subset of sub-arrays includes the information; and
after the powering up each sub-array of the subset of sub-arrays, accessing the information.

12. The method of claim 11, wherein the information to be accessed by the CPU includes code to be executed by the CPU.

13. The method of claim 12, further comprising:
receiving a next instruction to be executed by the CPU, wherein the determining the subset of sub-arrays to power up is based on an address of the next instruction, wherein the subset of the sub-arrays includes a sub-array containing the address of the next instruction.

14. The method of claim 13, wherein the subset of the sub-arrays further includes a sub-array physically closest to the sub-array containing the address of the next instruction.

15. The method of claim 13, further comprising:
storing a depth value, D, wherein D is an integer greater than zero, and wherein the subset of the sub-arrays includes D sub-arrays which contain addresses in sequence after the address of the next instruction.

16. The method of claim 11, wherein reducing power to each sub-array not in the subset of sub-arrays includes removing power from each sub-array not in the subset of sub-arrays.

17. A memory system comprising:
a memory array divided into a plurality of sub-arrays in which each sub-array has a mutually exclusive power domain;
task scheduler circuitry coupled to the memory array and configured to select a task for execution;
sub-array power control circuitry coupled to the task scheduler circuitry, wherein the task scheduler circuitry is configured to provide a control signal to the sub-array power control circuitry indicative of a set of sub-arrays to power based on the selected task, and the sub-array power control circuitry is configured to set a power state of each sub-array in response to the control signal.

18. The memory system of claim 17, wherein each sub-array comprises power gating circuitry, wherein the sub-array power control circuitry is configured to control the power gating circuitry of each sub-array to set the power state.

19. The memory system of claim 17, wherein the task scheduler circuitry comprises storage circuitry configured to store configuration information which indicates a corresponding set of sub-arrays used by each task of a plurality of tasks.

20. The memory system of claim 19, wherein the task scheduler circuitry is configured to provide the control signal based on the selected task and the configuration information.
